(19) United States
(12) Patent Application Publication
(10) Pub. No.: US 2021/0295109 A1
(43) Pub. Date: Sep. 23, 2021

(54) METHOD AND DEVICE FOR GENERATING PAINTING DISPLAY SEQUENCE, AND COMPUTER STORAGE MEDIUM

(71) Applicant: BOE TECHNOLOGY GROUP CO., LTD., Beijing (CN)

(72) Inventors: Xibo ZHOU, Beijing (CN); Hui LI, Beijing (CN)

(73) Assignee: BOE TECHNOLOGY GROUP CO., LTD., Beijing (CN)

(21) Appl. No.: 16/623,327

(22) PCT Filed: May 10, 2019
(86) PCT No.: PCT/CN2019/086426

§ 371 Date: Dec. 16, 2019

(30) Foreign Application Priority Data
Sep. 21, 2018 (CN) 201811105767.5

(51) Int. Cl. G06K 9/62

(52) U.S. Cl. CPC G06K 9/6269; G06K 9/6247; G06K 9/629; G06K 9/6222

(57) ABSTRACT

A method and device for generating a painting display sequence, and a computer storage medium are provided. The method for generating a painting display sequence comprises the following steps: acquiring painting data of a region of interest (ROI); clustering the painting data in a predetermined group and obtaining clustering results; and generating the painting display sequence according to the clustering result.

### CROSS-REFERENCE TO RELATED APPLICATION

This application is based on and claims priority of Chinese Patent Application No. 201811105767.5, filed on Sep. 21, 2018, which is incorporated herein by reference in its entirety for all purposes.

### TECHNICAL FIELD

The present disclosure relates to the technical field of data processing, and particularly relates to a method and device for generating a painting display sequence, and a computer storage medium.

### BACKGROUND

Screen for display screen may use lossless gamma technology, equipped with intelligent sensor adjustment. Painting resources displayed in the screen are becoming increasingly richer. The systems can obtain a painting display sequence according to the correlation between paintings, and then recommend a painting display sequence to users, thereby improving the recommending efficiency. In addition, regarding on-line painting appreciation and dealing platforms and off-line painting exhibitions, generation of painting display sequences can effectively determine the topics and the exhibition areas, and can instruct the structure of the platforms and the flow of the exhibitions.

### SUMMARY

The present disclosure provides a method, a device and a non-transitory computer storage medium for generating a painting display sequence.

According to a first aspect, a method for generating a painting display sequence is provided. The method may include acquiring painting data and user behavior data; clustering the painting data in a predetermined group to obtain a clustering result; and generating a painting display sequence according to the clustering result.

According to a second aspect, a device for generating a painting sequence is provided. The device may include a memory; and one or more processors, where the memory and the one or more processors are connected with each other; and the memory stores computer-executable instructions for controlling the one or more processors to: acquire, by an inputting layer, painting data and user behavior data; cluster, by a clustering layer, the painting data in a predetermined group to obtain a clustering result; and generate, by an outputting layer, the painting display sequence according to the clustering result.

According to a third aspect, a non-transitory computer storage medium is provided. The non-transitory computer storage medium may include computer executable instructions that when executed by one or more processors, cause the one or more processors to perform acquiring painting data and user behavior data; clustering the painting data in a predetermined group to obtain a clustering result; and generating a painting display sequence according to the clustering result.

It is to be understood that the above general description and the detailed description below are only exemplary and explanatory and not intended to limit the present disclosure.

### BRIEF DESCRIPTION OF THE PAINTINGS

The accompanying paintings, which are incorporated in and constitute a part of this specification, illustrate examples consistent with the present disclosure and, together with the description, serve to explain the principles of the present disclosure.

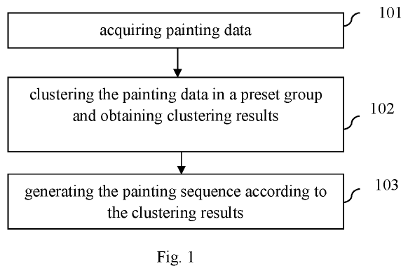

FIG. 1 is a schematic flow chart showing a method for generating a painting display sequence according to an example of the present disclosure.

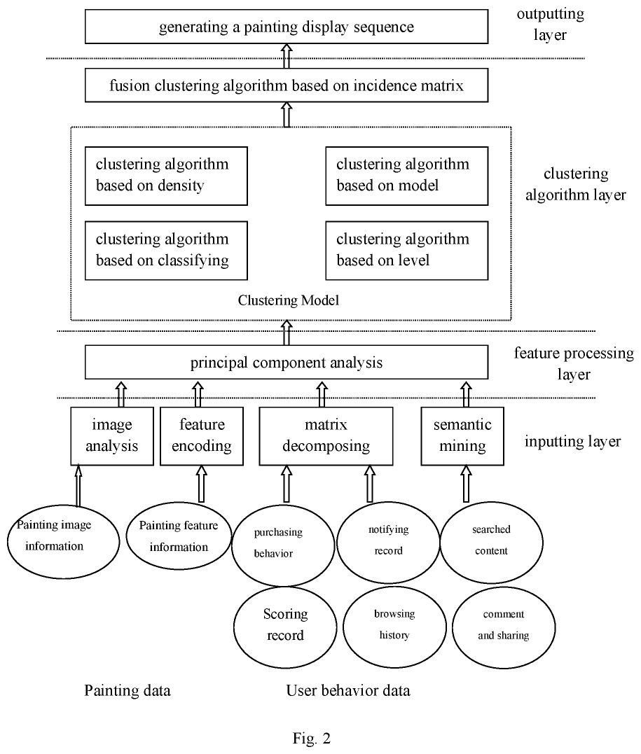

FIG. 2 illustrates data flowing of a method for generating a painting display sequence according to an example of the present disclosure.

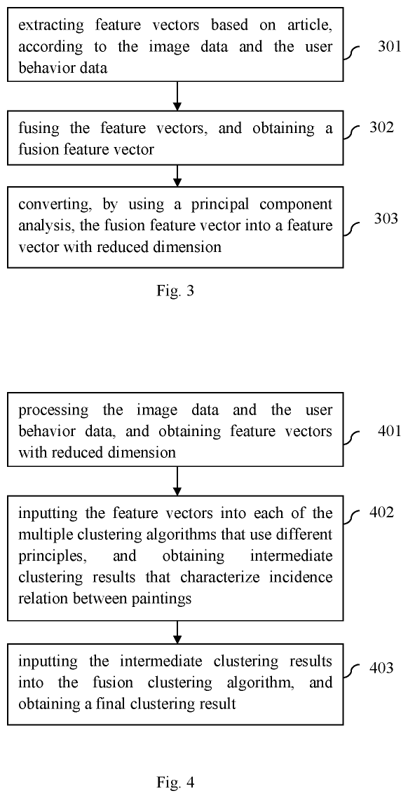

FIG. 3 is a schematic flow chart of acquiring feature vectors with reduced dimension according to an example of the present disclosure.

FIG. 4 is a schematic flow chart of acquiring a final clustering result according to an example of the present disclosure.

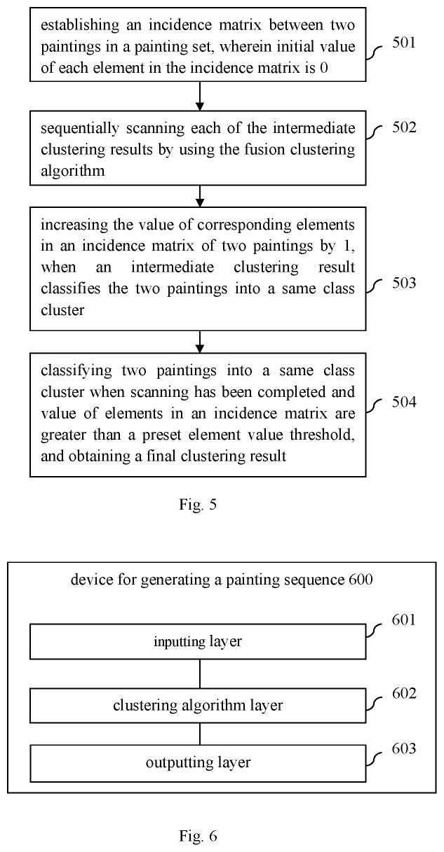

FIG. 5 is a schematic flow chart of fusing intermediate clustering results and obtaining a final clustering result according to an example of the present disclosure.

FIGS. 6-10 are block diagrams of a device for generating a painting display sequence according to an example of the present disclosure.

### DETAILED DESCRIPTION

Reference will now be made in detail to examples of which are illustrated in the accompanying drawings. The following description refers to the accompanying drawings in which the same numbers in different drawings represent the same or similar elements unless otherwise represented. The implementations set forth in the following description of examples do not represent all implementations consistent with the disclosure. Instead, they are merely examples of apparatuses and methods consistent with aspects related to the disclosure as recited in the claims.

The terminology used in the present disclosure is for the purpose of describing exemplary examples only and is not intended to limit the present disclosure. As used in the present disclosure and the claims, the singular forms “a” “an” and “the” are intended to include the plural forms as well, unless the context clearly indicates otherwise. It shall also be understood that the terms “or” and “and/or” as used herein are intended to signify and include any or all possible combination of one or more associated listed items, unless the context clearly indicates otherwise.

It shall be understood that, although the terms “first,” “second,” “third,” etc. may be used herein to describe various information, the information should not be limited by these terms. These terms are only used to distinguish one category of information from another. For example, without departing from the scope of the present disclosure, first information may be termed as second information; and similarly, second information may also be termed as first information. As used herein, the term “if” may be understood to mean “when” or “upon” or “in response to” depending on the context.

Reference throughout this specification to “one example,” “an example,” “another example,” or the like in the singular or plural means that one or more particular features, structures, or characteristics described in connection with an example is included in at least one example of the present disclosure. Thus, the appearances of the phrases “in one example” or “in an example,” “in another example,” or the like in the singular or plural in various places throughout this specification are not necessarily all referring to the same example. Furthermore, the particular features, structures, or characteristics in one or more examples may include combined in any suitable manner.

Screen for display screen may use lossless gamma technology, equipped with intelligent sensor adjustment. Display and intelligent light sensing technology may restore the true texture of the artwork: through the application APP and the cloud database, the screen ecosystem can be constructed from the four dimensions of the content library, users, collectors and uploaders, so that consumers can stay at home. The world of art treasures may thus be browsed. The disclosed screen contains an art content library, an art appreciation trading platform, a display terminal that restores the original art, and more additional services. Such screens may appear in many life scenes, with its extraordinary visual expression and powerful interactive functions, conveying the beauty of the combination of technology and art in the era of the Internet of Things.

Some methods for generating a painting display sequence require manual reviewing and topic (or keyword) labeling, and then process the labeled contents, thereby obtaining the painting display sequence. However, it is getting more difficult to generate a painting display sequence because painting information comprises multiple types of data such as images, texts and matrices.

An example of the present disclosure provides a method for generating a painting display sequence, one concept of which is that, this example uses the painting data that can reflect the features of the painting as the inputted data. The painting data comprise at least: painting image information and painting feature information. The painting image information refers to the content of the painting image. The painting feature information comprises at least one of the following: category, topic, size, author, year, and material.

This example also acquires the user behavior data as inputted data. The user behavior data comprise at least: structured behavior data and unstructured behavior data. The structured behavior data refer to the behavior data that are stored in the form of matrix and so on, and may comprise for example at least one of the following: purchasing behavior, scoring record, browsing history and notifying record. The unstructured behavior data refer to the behavior data that are stored in the form of text and so on, and may comprise for example at least one of the following: searched content, comment and shared content. Accordingly, on the basis of the above inputted data, this example cannot only reflect the features of the painting itself by using the painting data, but also can reflect the subjective features of the user hobbies by using the user behavior data. In other words, this example comprehensively considers the painting and the user hobby, thereby facilitating matching a painting display sequence that further meets the user hobbies.

Moreover, this example provides a method for generating a painting display sequence, another concept of which is that, it presets a group of clustering algorithms comprising at least multiple clustering algorithms that use different principles and a fusion clustering algorithm that fuses clustering results of the clustering algorithms that use different principles. The multiple clustering algorithms that use different principles comprise at least the following two: clustering algorithm based on classifying, clustering algorithm based on level, clustering algorithm based on density and clustering algorithm based on model. Finally, this example can generate a painting display sequence for users according to the clustering result obtained by using clustering algorithms in the group. Accordingly, this example can solve the problem in the prior art that a single clustering algorithm cannot cluster a painting display sequence and can only employ manual labeling, which causes more difficulties in generating painting display sequence. In other words, this example can, by using a group of clustering algorithms, reduce the difficulty in generating painting display sequence, and improve the generating efficiency.

The present disclosure facilitates improving the recommendation efficiency by adding user behavior data and determining the painting display sequence on the basis of user hobby. In addition, the present disclosure uses the group of clustering algorithms (comprising multiple clustering algorithms) to cluster painting data, thereby improving the efficiency and accuracy of generating the painting display sequence.

FIG. 1 is a schematic flow chart showing a method for generating a painting display sequence according to an example of the present disclosure, which can be applied to electronic devices such as a personal computer and a smart phone. FIG. 2 illustrates data flowing of a method for generating a painting display sequence according to an example of the present disclosure.

Referring to FIGS. 1 and 2, a method for generating a painting display sequence comprises steps 101 to 103. The step of 101 is acquiring painting data and user behavior data. Referring to FIG. 2, in this example, the electronic device may comprise an inputting layer, for acquiring painting data and user behavior data. The inputting layer may be a communication interface for connecting to an external server, and may also be a designated location (for example a memory, a buffer or a mobile hard disk drive and so on).

Preferably, an electronic device may acquire the painting data. If the painting data are stored at a designated location, the electronic device may acquire the painting data from the designated location. If the painting data are stored at a server, the electronic device may download the painting data from the server by communicating with the server.

Preferably, the electronic device may also acquire the user behavior data. If the user behavior data and the painting data are stored at the same location, for example a designated location or the server, the user behavior data of the paintings may be acquired simultaneously when the painting data are acquired. If the painting data and the user behavior data are stored separately, for example, the painting data are at the server and the user behavior data are at the electronic device, then the user behavior data may be acquired on the basis of the location corresponding to the identification of the painting data.

The step of 102 is clustering the painting data and the user behavior data by using clustering algorithms in a preset group and obtaining clustering results.

Referring to FIG. 2, the electronic device may comprise a feature processing layer and a clustering algorithm layer. The feature processing layer extracts feature vectors with reduced dimension from the painting data and user behavior data; and the clustering algorithm layer clusters the painting data and the user behavior data by using a preset group of clustering algorithms, and obtains clustering results. Preferably, the feature vectors with reduced dimension refer to a group of feature vectors that are linearly independent and have reduced dimension.

Preferably, the group of clustering algorithms may be preset at a designated location in the electronic device, and may also be stored at a server.

The electronic device may call the group of clustering algorithms before, after or during acquiring the painting data and the user behavior data, and cluster the painting data and the user behavior data by using the group of clustering algorithms, thereby obtaining the clustering results.

FIG. 3 is a schematic flow chart of acquiring feature vectors with reduced dimension according to an example of the present disclosure. In this example, the electronic device firstly processes the painting data and the user behavior data, and obtains feature vectors based on article (corresponding to Step 301).

Specifically, the electronic device extracts, on a layer-by-layer basis and by using a stacked auto-encoder, features from painting image information of the painting data, reduces dimension of the extracted features, and obtains a high-order feature vector corresponding to the painting data. Such a process realizes converting the data of high-pixel painting images into a series of simple high-order feature vectors.

Moreover, the electronic device encodes, by using one-hot encoder, a category feature from painting category information of the painting data, normalizes the category feature, and obtains a first painting feature vector; and decomposes structured behavior data by using alternating least squares.

The alternating least squares may be expressed by the following formula:

A_{m×n}≈U_{m×k}×I_{n×k}^{T}

wherein m is the quantity of the users, n is the quantity of the paintings, k is the quantity of the latent features, I_{n×k} is painting feature vectors that characterize the similarity of the purchasing and scoring behaviors of users, and U_{m×k} characterizes user-latent features, that is, the user preference. In this example, because the latent features are shared by U_{m×k} and I_{n×k} at that dimension, if the similarity between the feature vectors of two paintings in I_{n×k} is higher, it is indicated that the similarity between the corresponding user preference vectors is also higher.

Here, A is a sparse matrix, and the purpose of the alternating least squares is to postulate the missing terms. The idea is to find U and I in order to approximate A (when calculating the error, merely all of the nonempty terms are taken), reduce the error by iteration training, and finally find the optimal solution. Because the error has a lower limit, the formula uses the approximation sign.

The electronic device extracts, by using latent dirichlet allocation, a latent topic probability vector from unstructured behavior data of the user behavior data.

Preferably, the high-order feature vector, the first painting feature vector, the second painting feature vector and the latent topic probability vector are feature vectors based on article.

Referring to FIG. 3, the electronic device fuses the feature vectors based on article acquired previously, and can obtain a fusion feature vector (corresponding to Step 302). For example, multiple feature vectors based on feature are merged into a vector that has a same dimension but includes a different quantity of elements. For example, regarding a painting p, assuming that the first painting feature vector is [f₁, . . . , fᵢ] and the second painting feature vector is [fᵢ₊₁, . . . , fⱼ], the fusion feature vector of the two vectors is [f₁, . . . , fᵢ, fᵢ₊₁, . . . , fⱼ], and that can be deduced accordingly to the case of multiple vectors. Then, the electronic device converts, by using a principal component analysis, the fusion feature vector into the feature vector with reduced dimension (corresponding to Step 303).

FIG. 4 is a schematic flow chart of acquiring a final clustering result according to an example of the present disclosure. In this example, the electronic device, after acquiring the feature vectors with reduced dimension (corresponding to Step 401), sequentially inputs the feature vectors with reduced dimension into the multiple clustering algorithms that use different principles in the group, and the clustering algorithms will obtain an intermediate clustering result (corresponding to Step 402), comprising:

(1) clustering algorithm based on classifying, such as K-means algorithm or K-medoids algorithm: taking a sample set in the feature vectors with reduced dimension as N class clusters, by firstly selecting N samples as an initial center, then using a heuristic algorithm to classify the sample set into the nearest center, adjusting the center position, and reiterating and resetting repeatedly, till the effect that “the distances between the intra-class samples are small enough, and the distances between the inter-class samples are large enough” is reached, and obtaining an intermediate clustering result.

(2) clustering algorithm based on level, such as BIRCH algorithm: using a method from bottom to top, wherein initially each of the samples serves as one class itself, each time forming a upper level of cluster by merging the most similar classes, and ending when a termination condition (for example N class clusters remain) is satisfied; or, using a method from top to bottom, wherein initially all of the samples are contained in one class, each time classifying the parent class into several sub-clusters, and ending when a termination condition is satisfied. Accordingly, an intermediate clustering result can be obtained.

(3) clustering based on density, such as DBSCAN algorithm or OPTICS algorithm: defining two parameters of region radius and density, then traversing the sample set by using a heuristic algorithm, and when the density of a region adjacent to a certain sample (generally referring to the quantity of the other samples that fall within the adjacent region) exceeds a certain threshold, clustering those samples, to finally form several class clusters with concentrated densities, and then obtain an intermediate clustering result.

(4) clustering based on model, such as GMM algorithm or SOM algorithm: assuming that the sample set is generated according to a potential probability distribution, seeking by using a mixed probability generation model the best fit of the sample set with respect to the model, and finally sample sets that satisfy a same class belong to the same probability distribution.

Accordingly, the electronic device can obtain the intermediate clustering results that have the same quantity as that of the multiple clustering algorithms that use different principles.

Then, the electronic device inputs the multiple intermediate clustering results into the fusion clustering algorithm in the group, and obtains a final clustering result (corresponding to Step 403).

Referring to FIG. 5, the clustering process comprises Step 501: establishing a incidence matrix C_(n×n) between any two paintings in a painting set, wherein the initial value of the elements are 0, and n represents the quantity of the paintings that participate in generating the painting display sequence;

Step 502: sequentially scanning the intermediate clustering results, and if the paintings Iᵢ and Iⱼ are classified into a same class cluster in a certain intermediate clustering result, increasing the value of the corresponding position C_(i, j) in the incidence matrix by 1;

Step 503, after the scanning of all of the intermediate clustering results has been completed, sequentially counting the final value of each of the elements in the incidence matrix C_(n×n). If the final value is greater than a preset element value threshold, classifying the two paintings corresponding to the element into a same class cluster;

Step 504, obtaining the final clustering result according to the result of classifying the class clusters of Step 503; and

Step 103, generating a painting display sequence according to the final clustering result.

In this example, the outputting layer of the electronic device generates a painting display sequence according to the clustering result of the final terminal, wherein the painting set in a same class cluster and a same clustering result serves as one painting display sequence.

This example facilitates improving the recommendation efficiency by adding the user behavior data and determining the painting display sequence on the basis of the hobby of the user. In addition, this example uses a group of clustering algorithms (comprising multiple clustering algorithms) to cluster painting data, thereby improving the efficiency and accuracy of generating painting display sequence.

FIG. 6 is a device for generating a painting display sequence according to an example of the present disclosure. Referring to FIG. 6, the device 600 comprises an inputting layer 601, a clustering algorithm layer 602 and an outputting layer 603; wherein

the inputting layer 601 acquires painting data and user behavior data;

the clustering algorithm layer 602 clusters the painting data and the user behavior data by using clustering algorithm in a preset group, and obtains clustering results; and

the outputting layer 603 generates a painting display sequence according to the clustering results.

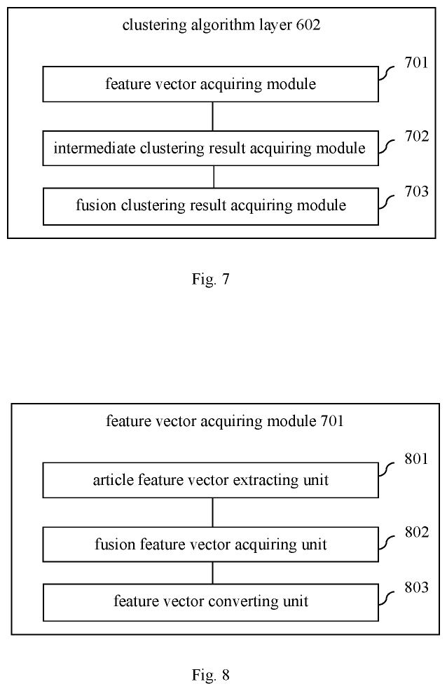

Referring to FIG. 7, according to the device shown in FIG. 6, the clustering algorithm layer 602 further comprises a feature vector acquiring module 701, an intermediate clustering result acquiring module 702 and a fusion clustering result acquiring module 703.

The feature vector acquiring module 701 processes the painting data and the user behavior data, and obtains a feature vector with reduced dimension.

The intermediate clustering result acquiring module 702 inputs feature vectors with reduced dimension into the clustering algorithms, and obtains intermediate clustering results that characterize incidence relation between paintings.

And the fusion clustering result acquiring module 703 inputs the intermediate clustering results of each of the clustering algorithms into the fusion clustering algorithm, and obtains a final clustering result.

Referring to FIG. 8, according to the device shown in FIG. 7, the feature vector acquiring module 701 further comprises: an article feature vector extracting unit 801 extracting feature vectors based on article according to the painting data and the user behavior data; a fusion feature vector acquiring unit 802 fusing the feature vectors based on article and obtains a fusion feature vector; and a feature vector converting unit 803 converting, by using a principal component analysis, the fusion feature vector into a feature vector with reduced dimension.

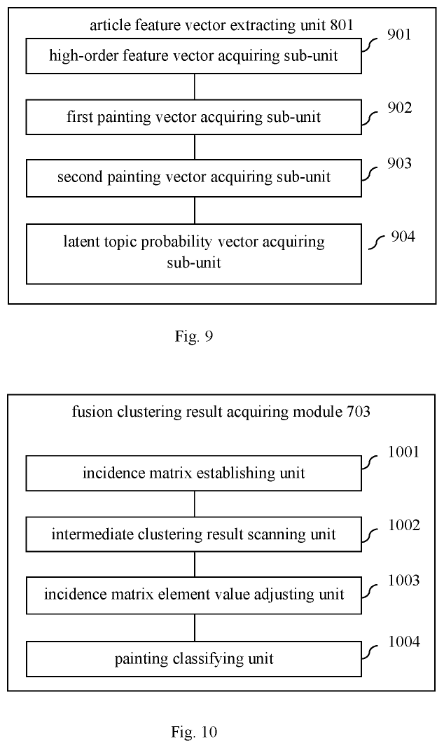

Referring to FIG. 9, according to the device shown in FIG. 8, the article feature vector extracting unit 801 further comprises: a high-order feature vector acquiring sub-unit 901 extracting, on a layer-by-layer basis and by using a stacked auto-encoder, features from painting image information of the painting data, reducing dimension of the extracted features, and obtaining a high-order feature vector corresponding to the painting data;

a first painting vector acquiring sub-unit 902 encoding, by using one-hot encoder, a category feature from painting category information of the painting data, normalizing the category feature, and obtaining a first painting feature vector;

a second painting vector acquiring sub-unit 903 decomposing, by using alternating least squares, structured behavior data, and obtaining a second painting feature vector; and

a latent topic probability vector acquiring sub-unit 94 extracting, by using latent dirichlet allocation, a latent topic probability vector from unstructured behavior data of the user behavior data;

wherein the high-order feature vector, the first painting feature vector, the second painting feature vector and the latent topic probability vector are feature vectors based on article.

Referring to FIG. 10, according to the device shown in FIG. 7, the fusion clustering result acquiring module 703 further comprises:

an incidence matrix establishing unit 1001, establishing an incidence matrix between two paintings in a painting set, wherein initial value of each element in the incidence matrix is 0;

an intermediate clustering result scanning unit 1002, sequentially scanning each of the multiple intermediate clustering results by using the fusion clustering algorithm;

an incidence matrix element value adjusting unit 1003, adjusting value of corresponding elements in a preset incidence matrix of two paintings when an in intermediate clustering result classifies the two paintings into a same class cluster; and

a painting classifying unit 1004, classifying two paintings into a same class cluster, when the scanning has been completed and value of elements in an incidence matrix are greater than a preset element value threshold, and obtaining a final clustering result.

The present disclosure further provides a computer storage medium encoding computer executable instructions that when executed by one or more processors, cause the one or more processors to perform operations comprising:

S1: acquiring painting data and user behavior data; S2: clustering the painting data and the user behavior data by using a preset group of clustering algorithms and obtaining a clustering result; and S3: generating the painting display sequence according to the clustering result.

The preset group may comprise multiple clustering algorithms that use different principles and a fusion clustering algorithm that fuses the clustering results.

Moreover, the operation S2 further comprises: S21: processing the painting data and the user behavior data, and obtaining feature vectors with reduced dimension; S22: inputting the feature vectors into each of the multiple clustering algorithms, and obtaining intermediate clustering results that characterize incidence relation between paintings; and S23: inputting the intermediate clustering results into the fusion clustering algorithm, and obtaining a final clustering result.

Furthermore, the operation of S21 may comprise: S211: extracting feature vectors based on article, according to the painting data and the user behavior data; S212: fusing the feature vectors, and obtaining a fusion feature vector; and S213: converting, by using a principal component analysis, the fusion feature vector into a feature vector with reduced dimension.

Additionally, the operation of S211 may further comprise:

extracting, on a layer-by-layer basis and by using a stacked auto-encoder, features from painting image information of the painting data, reducing dimension of the extracted features, and obtaining a high-order feature vector corresponding to the painting data;

encoding, by using one-hot encoder, a category feature from painting category information of the painting data, normalizing the category feature, and obtaining a first painting feature vector;

decomposing, by using alternating least squares, structured behavior data from the user behavior data, and obtaining a second painting feature vector; and

extracting, by using latent dirichlet allocation, a latent topic probability vector from unstructured behavior data of the user behavior data.

The high-order feature vector, the first painting feature vector, the second painting feature vector and the latent topic probability vector are feature vectors based on article.

The operation of S23 may further comprise: S231: establishing an incidence matrix between two paintings in a painting set, wherein initial value of each element in the incidence matrix is 0; S232: sequentially scanning each of the intermediate clustering results by using the fusion clustering algorithm; S233: adjusting the value of corresponding elements in an incidence matrix of two paintings, when an intermediate clustering result classifies the two paintings into a same class cluster; S234: classifying two paintings into a same class cluster when scanning has been completed and value of elements in an incidence matrix are greater than a preset element value threshold, and obtaining a final clustering result.

In another aspect, the present disclosure provides an apparatus. In some embodiments, the apparatus includes a memory; and one or more processors. The memory and the one or more processors are connected with each other. In some embodiments, the memory stores computer-executable instructions for controlling the one or more processors.

The method according to the present disclosure may be implemented on a computing device in the form on a general-purpose computer, a microprocessor, in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

As used herein, the term “computer-readable medium” refers to any computer program product, apparatus and/or device (e.g., magnetic discs, optical disks, memory, Programmable Logic Devices (PLDs) used to provide machine instructions and/or data to a programmable processor, including a machine readable medium that receives machine instructions as a machine-readable signal. The term “machine-readable signal” refers to any signal used to provide machine instructions and/or data to a programmable processor. The computer-readable medium according to the present disclosure includes, but is not limited to, random access memory (RAM), a read-only memory (ROM), a non-volatile random access memory (NVRAM), a programmable read-only memory (PROM), erasable programmable read-only memory (EPROM), electrically erasable PROM (EEPROM), flash memory, magnetic or optical data storage, registers, disk or tape, such as compact disk (CD) or DVD (digital versatile disc) optical storage media and other non-transitory media.

The present disclosure may include dedicated hardware implementations such as application specific integrated circuits, programmable logic arrays and other hardware devices. The hardware implementations can be constructed to implement one or more of the methods described herein. Applications that may include the apparatus and systems of various examples can broadly include a variety of electronic and computing systems. One or more examples described herein may implement functions using two or more specific interconnected hardware modules or devices with related control and data signals that can be communicated between and through the modules, or as portions of an application-specific integrated circuit. Accordingly, the system disclosed may encompass software, firmware, and hardware implementations. The terms “module,” “sub-module,” “circuit,” “layer,” “sub-circuit,” “circuitry,” “sub-circuitry,” “unit,” or “sub-unit” may include memory (shared, dedicated, or group) that stores code or instructions that can be executed by one or more processors. The module refers herein may include one or more circuit with or without stored code or instructions. The module or circuit may include one or more components that are connected.

It should be noted that the examples of the present disclosure are well implemented, and do not make limitations of any form to the present disclosure. Any changes or modifications that may be made by the technicians familiar with this field using the above-disclosed technical contents are equally effective examples. Any modifications or equivalent changes and polishes made on the above disclosed examples, which are not independent of the contents of the technical schemes of the present disclosure, and are in accordance with the technical essence of the present disclosure, and are in accordance with the technical essence of the present disclosure, are still covered in the scope of the technical schemes of the present disclosure.

1. A method for generating a painting display sequence, comprising the steps of:
acquiring painting data and user behavior data;
clustering the painting data in a predetermined group to obtain a clustering result; and
generating a painting display sequence according to the clustering result.

2. The method of claim 1, wherein the predetermined group comprises multiple clustering algorithms that use different principles and a fusion clustering algorithm that fuses the clustering result.

3. The method of claim 2, wherein clustering the painting data further comprises
processing the painting data, and obtaining feature vectors with reduced dimension;
inputting the feature vectors into each of the multiple clustering algorithms, and obtaining intermediate clustering results that characterize incidence relation between paintings; and
inputting the intermediate clustering results into the fusion clustering algorithm, and obtaining the clustering result.

4. The method of claim 2, wherein the multiple clustering algorithms that use different principles comprise at least two of:
clustering algorithm based on classifying, clustering algorithm based on level, clustering algorithm based on density, and clustering algorithm based on model.

5. The method of claim 3, wherein processing the painting data further comprises:
extracting feature vectors based on article according to the painting data and the user behavior data;
fusing the feature vectors, and obtaining a fusion feature vector; and
converting, by using a principal component analysis, the fusion feature vector into a feature vector with reduced dimension.

6. The method of claim 5, wherein extracting the feature vectors further comprises:
extracting, on a layer-by-layer basis and by using a stacked auto-encoder, features from painting image information of the painting data, reducing dimension of the extracted features, and obtaining a high-order feature vector corresponding to the painting data;
encoding, by using one-hot encoder, a category feature from painting category information of the painting data, normalizing the category feature, and obtaining a first painting feature vector;
decomposing, by using alternating least squares, structured behavior data from user behavior data, and obtaining a second painting feature vector; and
extracting, by using latent dirichlet allocation, a latent topic probability vector from unstructured behavior data of the user behavior data; and
wherein the high-order feature vector, the first painting feature vector, the second painting feature vector and the latent topic probability vector are feature vectors based on article.

7. The method of claim 3, wherein inputting the intermediate clustering results further comprises:
establishing an incidence matrix between two paintings in a painting set, wherein initial value of each element in the incidence matrix is 0;
sequentially scanning each of the intermediate clustering results by using the fusion clustering algorithm;
adjusting the value of corresponding elements in an incidence matrix of two paintings, when an intermediate clustering result classifies the two paintings into a same class cluster; and
classifying two paintings into a same class cluster when scanning has been completed and value of elements in an incidence matrix are greater than a predetermined element value threshold, and obtaining a final clustering result.

8. The method of claim 7, wherein adjusting the value of corresponding elements further comprises:
increasing the value of corresponding elements in an incidence matrix of two paintings by 1, when an intermediate clustering result classifies the two paintings into a same class cluster.

9. The method of claim 1, wherein the painting data comprise painting image information and painting feature information, and the painting feature information comprises at least one of the following: category, topic, size, author, year, and material.

10. A device for generating a painting list, comprising:
a memory; and
one or more processors, wherein the memory and the one or more processors are connected with each other; and
the memory stores computer-executable instructions for controlling the one or more processors to:
acquire, by an inputting layer, painting data and user behavior data;
cluster, by a clustering layer, the painting data in a predetermined group to obtain a clustering result; and
generate, by an outputting layer, the painting display sequence according to the clustering result.

11. The device of claim 10, wherein the predetermined group comprises multiple clustering algorithms that use different principles and a fusion clustering algorithm that fuses the clustering result.

12. The device of claim 11, wherein the clustering layer further comprises:
a feature vector acquiring module that processes the painting data, and obtains feature vectors with reduced dimension;
an intermediate clustering result acquiring module that inputs the feature vectors into each of the multiple clustering algorithms, and obtains intermediate clustering results that characterize incidence relation between paintings; and
a fusion clustering result acquiring module that inputs the intermediate clustering results into the fusion clustering algorithm, and obtains a final clustering result.

13. The device of claim 11, wherein the feature vector acquiring module further comprises:
an article feature vector extracting unit that extracts feature vectors based on article, according to the painting data and user behavior data;
a fusion feature vector acquiring unit that fuses the feature vectors and obtains a fusion feature vector; and
a feature vector converting unit that converts, by using a principal component analysis, the fusion feature vector into a feature vector with reduced dimension.

14. The device of claim 13, wherein the article feature vector extracting unit further comprises:
a high-order feature vector acquiring sub-unit that extracts, on a layer-by-layer basis and by using a stacked auto-encoder, features from painting image information of the painting data, reduces dimension of the extracted features, and obtains a high-order feature vector corresponding to the painting data;
a first painting vector acquiring sub-unit that encodes, by using one-hot encoder, a category feature from painting category information of the, normalizes the category feature, and obtains a first painting feature vector;
a second painting vector acquiring sub-unit that decomposes, by using alternating least squares, structured behavior data and obtaining a second painting feature vector; and
a latent topic probability vector acquiring sub-unit that extracts, by using latent dirichlet allocation, a latent topic probability vector from unstructured behavior data of the user behavior data;
wherein the high-order feature vector, the first painting feature vector, the second painting feature vector and the latent topic probability vector are feature vectors based on article.

15. The device of claim 12, wherein the fusion clustering result acquiring module further comprises:
an incidence matrix establishing unit that establishes an incidence matrix between two paintings in a painting set, wherein initial value of each element in the incidence matrix is 0;
an intermediate clustering result scanning unit that sequentially scans each of the multiple intermediate clustering results by using the fusion clustering algorithm;
an incidence matrix element value adjusting unit that adjusts value of corresponding elements in a predetermined incidence matrix of two paintings when an intermediate clustering result classifies the two paintings into a same class cluster; and
a painting classifying unit that classifies two paintings into a same class cluster when scanning has been completed and value of element in an incidence matrix are greater than a predetermined element value threshold and obtaining a final clustering result.

16. A non-transitory computer storage medium comprising computer executable instructions that when executed by one or more processors, cause the one or more processors to perform:
acquiring painting data and user behavior data;
clustering the painting data in a predetermined group to obtain a clustering result; and
generating a painting display sequence according to the clustering result.

17. The non-transitory computer storage medium of claim 16, wherein the predetermined group comprises multiple clustering algorithms that use different principles and a fusion clustering algorithm that fuses the clustering result.

18. The non-transitory computer storage medium of claim 17, wherein the instructions that cause the one or more processors to perform clustering the painting data further cause the one or more processors to perform:
processing the painting data, and obtaining feature vectors with reduced dimension;
inputting the feature vectors into each of the multiple clustering algorithms, and obtaining intermediate clustering results that characterize incidence relation between paintings; and
inputting the intermediate clustering results into the fusion clustering algorithm, and obtaining the clustering result.

19. The non-transitory computer storage medium of claim 18, wherein the instructions that cause the one or more processors to perform processing the painting data further cause the one or more processors to perform:
extracting feature vectors based on article, according to the painting data and the user behavior data;
fusing the feature vectors, and obtaining a fusion feature vector; and
converting, by using a principal component analysis, the fusion feature vector into a feature vector with reduced dimension.

20. The computer storage medium of claim 19, wherein the instructions that cause the one or more processors to perform extracting the feature vectors further cause the one or more processors to perform:
extracting, on a layer-by-layer basis and by using a stacked auto-encoder, features from painting image information of the painting data, reducing dimension of the extracted features, and obtaining a high-order feature vector corresponding to the painting data;
encoding, by using one-hot encoder, a category feature from painting category information of the painting data, normalizing the category feature, and obtaining a first painting feature vector;
decomposing, by using alternating least squares, structured behavior data from the user behavior data, and obtaining a second painting feature vector; and
extracting, by using latent dirichlet allocation, a latent topic probability vector from unstructured behavior data of the user behavior data; and
wherein the high-order feature vector, the first painting feature vector, the second painting feature vector and the latent topic probability vector are feature vectors based on article.

21. (canceled)
